(19) United States
(12) Patent Application Publication
(10) Pub. No.: US 2013/0133911 A1
(43) Pub. Date: May 30, 2013

(54) ROTARY IMPACT TOOL

(71) Applicants: Goshi ISHIKAWA, Anjo-shi (JP); Yoshitaka ICHIKAWA, Anjo-shi (JP)

(72) Inventors: Goshi ISHIKAWA, Anjo-shi (JP); Yoshitaka ICHIKAWA, Anjo-shi (JP)

(21) Appl. No.: 13/684,870

(22) Filed: Nov. 26, 2012

(30) Foreign Application Priority Data
Nov. 30, 2011 (JP) 2011-262338

(51) Int. Cl. B25B 21/00; B25D 11/06

(52) U.S. Cl. CPC B25B 21/00; B25D 11/068
USPC 173/176; 173/93.5

(57) ABSTRACT

There is provided a rotary impact tool that includes: a motor; a hammer configured to be rotated by the motor; an anvil configured to be intermittently applied with an impact force in a rotation direction by a rotational force of the hammer; a rotation speed detection device configured to detect a rotation speed of the motor; an extreme value pair detection device configured to detect an extreme value pair, which is a pair of a maximum value and a minimum value of the rotation speed, based on the rotation speed detected by the rotation speed detection device; and an impact detection device configured to detect that the impact force is being applied when an extreme value difference, which is a difference between the maximum value and the minimum value, is equal to or more than a first threshold value.

### CROSS-REFERENCE TO RELATED APPLICATIONS

This application claims the benefit of Japanese Patent Application No. 2011-262338 filed Nov. 30, 2011 in the Japan Patent Office, the disclosure of which is incorporated herein by reference.

### BACKGROUND

The present invention relates to a rotary impact tool configured to be rotated by a rotational force of a motor and apply an intermittent impact force toward a rotation direction when a torque having a predetermined value or more is applied.

A known example of such rotary impact tool is an impact driver capable of, for example, tightening a screw at a high torque utilizing an impact force. When tightening a screw using an impact driver, an operator himself/herself generally confirms that the screw has been seated and then turns off a trigger switch to stop a motor.

However, it is difficult to turn off the trigger switch to stop the motor immediately after the screw has been seated in a case of tightening a screw in a light-loaded condition by a high-speed rotation. For example, an excessive torque when an impact is applied due to the high-speed rotation may cause the screw head to be stripped or damaged.

To address such problem, there is a known technique to prevent damage or the like of a screw even when tightening the screw by a high-speed rotation as described, for example, in Japanese Unexamined Patent Application Publication No. 2010-207951, in which a device to detect an impact is provided and a rotation speed of a motor is switched from a normal speed to a low speed when an impact is detected.

### SUMMARY

According to the technique described in Japanese Unexamined Patent Application Publication No. 2010-207951, detection of an impact is performed by detecting a vibration or an impact sound when an impact is applied, using a piezoelectric sensor, an acceleration sensor, or a shock sensor, such as a piezoelectric buzzer or a microphone.

Depending on a material constituting an object to which a screw or the like is tightened, an amount of load to be applied to a tool during tightening may be unstable. In such a case, it is difficult to accurately detect an impact. For example, it may occur that an impact is misdetected in an early stage, and thereby the motor is decelerated at an unintended timing. It may also occur that although an impact is started, the impact is not detected, and thereby a screw head is stripped or damaged.

It is, therefore, desirable that detection of an impact in a rotary impact tool can be performed highly accurately and rapidly.

A rotary impact tool according to the present invention includes a motor, a hammer, an anvil, a rotation speed detection device, an extreme value pair detection device, and an impact detection device. The hammer is configured to be rotated by a rotational force of the motor. The anvil is mounted with an output shaft to which a tool element is attached, and is configured to be rotated receiving a rotational force of the hammer and to be intermittently applied with an impact force in a rotation direction by a rotational force of the hammer when an external torque of a predetermined value or more is exerted due to a rotation of the anvil. The rotation speed detection device is configured to detect a rotation speed of the motor. The extreme value pair detection device is configured to detect an extreme value pair, which is a pair of a maximum value and a minimum value of the rotation speed occurring chronologically sequentially, based on the rotation speed detected by the rotation speed detection device. The impact detection device is configured to detect that the impact force is being applied when an extreme value difference, which is a difference between the maximum value and the minimum value constituting the extreme value pair detected by the extreme value pair detection device, is equal to or more than a first threshold value.

In the rotary impact tool configured as above, with respect to the rotation speed of the motor, at least a state of changes in the rotation speed is different between when application of an impact is performed (i.e., an impact force is being applied) and when application of an impact is not performed. The changes in the rotation speed here mean changes caused in synchronization with the rotation of the hammer.

During a normal rotation when application of an impact is not performed, changes in the rotation speed hardly occur. On the other hand, when application of an impact is performed, changes in the rotation speed occur due to a principle of generating an impact force. Specifically, when application of an impact is performed, the rotation speed of the motor generally becomes lowest immediately before the hammer leaves the anvil after riding over the anvil, and becomes highest when the hammer, which has once left the anvil, again strikes against the anvil (i.e., immediately before the impact force is applied.) Accordingly, the rotation speed of the motor changes periodically in synchronization with the rotation of the hammer.

Accordingly, in the rotary impact tool of the present invention, the maximum value and the minimum value of the rotation speed of the motor are detected chronologically sequentially. Then, when the difference (the extreme value difference) between the sequentially detected maximum value and minimum value (the extreme value pair) is equal to or more than the first threshold value, it is detected that application of an impact is performed. Since the rotation speed changes periodically and thereby the maximum value and the minimum value of the rotation speed occur periodically while application of an impact is performed, it is possible to detect application of an impact based on the extreme value difference by appropriately setting the first threshold value.

Therefore, according to the rotary impact tool of the present invention with the above configuration, detection of an impact is performed using changes in the rotation speed occurring when an impact is applied, and thus detection of an impact can be performed highly accurately and rapidly.

It is not a sufficient condition that the maximum value and the minimum value as the extreme value pair be chronologically sequential. For example, even when application of an impact is not performed, the rotation speed may be changed due to various disturbances, such as changes in a state of load or in a supplied power to the motor, and the like, which may result in sequential occurrence of the maximum value and the minimum value with a large time interval. In such case, there is a possibility that an impact may be misdetected if the difference between the maximum value and the minimum value is equal to or more than the first threshold value in spite of the fact that application of an impact is not performed.

To avoid such possibility, it is preferable that the extreme value pair detection device is configured to detect the maximum value and the minimum value as the extreme value pair when the maximum value and the minimum value occur chronologically sequentially within a predetermined time period.

By setting a limitation on the time interval between the maximum value and the minimum value which sequentially occur, it is possible to exclude an extreme value pair occurring due to a cause different from an impact, and thus it is possible to suppress misdetection of an impact.

Also, to suppress misdetection of an impact due to the aforementioned various disturbances and the like, a configuration below may be employed. Specifically, the impact detection device is configured to detect, with respect to a plurality of the extreme value pairs which are chronologically different from one another, that the impact force is being applied one of when the extreme value difference of each of the plurality of the extreme value pairs is equal to or more than the first threshold value, and when the extreme value difference of at least one of the extreme value pairs is equal to or more than the first threshold value and the extreme value difference of each of the other extreme value pairs is equal to or more than a second threshold value which is smaller than the first threshold value.

By determining whether or not the extreme value difference of each of the plurality of the extreme value pairs is equal to or more than the same first threshold value, or by using a plurality of threshold values, including the first threshold value, and determining whether or not each of extreme value differences is equal to or more than a corresponding one of the plurality of threshold values, it is possible to exclude an extreme value pair occurring due to a cause different from an impact, and thus it is possible to suppress misdetection of an impact.

There may be various specific detection methods in a case where the impact detection device performs detection using the plurality of extreme value pairs. For example, the impact detection device may be configured to, with respect to two of the extreme value pairs which are chronologically different from each other, first determine whether or not the extreme value difference of the extreme value pair which is detected earlier is equal to or more than the first threshold value; and subsequently determine, when the extreme value difference is equal to or more than the first threshold value, whether or not the extreme value difference of an extreme value pair which is detected later is equal to the more than the second threshold value, and detect, when the extreme value difference of the extreme value pair which is detected later is equal to or more than the second threshold value, that the impact force is being applied.

By sequentially using the first threshold value and the second threshold value with respect to the two extreme value pairs, it is possible to perform detection of an impact in a highly accurate manner while suppressing a processing load due to detection of an impact.

The plurality of extreme value pairs need not be chronologically completely different, but may be partially overlapped. For example, in a case where a maximum value is first detected and subsequently a minimum value is detected (for example, referred to as a “first extreme value pair”), an extreme value pair chronologically subsequent to the first extreme value pair may be an extreme value pair constituted by the minimum value, which is detected subsequent to the maximum value, of the first extreme value pair and a maximum value which is newly detected subsequent to the minimum value.

It may occur that, even when application of an impact is being performed, an impact is not detected (or detection of an impact is delayed) since the extreme value difference becomes temporarily smaller than the first threshold value due to some cause. Accordingly, it is preferable that the impact detection device is configured to, after starting detection by the impact detection device based on the extreme value difference: detect, when the extreme value difference of a first one of the extreme value pairs is equal to or more than the first threshold value, that the impact force is being applied; determine, when the extreme value difference of the first one of the extreme value pairs is not equal to or more than the first threshold value, whether or not the extreme value difference is equal to or more than a second threshold value, which is smaller than the first threshold value; further determine, when the extreme value difference is equal to or more than the second threshold value, whether or not the extreme value difference of at least one of the extreme value pairs chronologically later than the first one of the extreme value pairs is equal to or more than the first threshold value; and detects, when the extreme value difference of the at least one of the extreme value pairs is equal to or more than the first threshold value, that the impact force is being applied.

That is, when the extreme value difference is smaller than the first threshold value, the extreme value difference is compared with the second threshold value smaller than the first threshold value. If the extreme value difference is equal to or more than the second threshold value, it is tentatively determined that an impact is applied. Subsequently, in order to further surely confirm that an impact is applied, it is determined whether or not the extreme value difference of the later occurring extreme value pair is equal to or more than the first threshold value. Then, a detection is made that an impact is applied when the extreme value difference of the later occurring extreme value pair is equal to or more than the first threshold value.

Accordingly, if the extreme value difference becomes temporarily small due to some cause even when application of an impact is being performed, it is possible to detect the impact surely and promptly.

In general, the rotation speed of the motor when application of an impact is being performed is relatively smaller than the rotation speed of the motor during a normal rotation when application of an impact is not performed.

It is, therefore, preferable that the rotary impact tool includes a rotation number range determination device configured to determine whether or not both of the maximum value and the minimum value constituting the extreme value pair are within a predetermined rotation number range, and that the impact detection device is configured to determine whether or not the impact force is being applied when it is determined by the rotation number range determination device that both of the maximum value and the minimum value constituting the extreme value pair are within the predetermined rotation number range.

According to the rotary impact tool with such configuration, detection of an impact is performed considering whether or not both of the maximum value and the minimum value constituting the extreme value pair are within a predetermined rotation number range in addition to considering the extreme value difference. Thus, an increased accuracy in detection of an impact may be achieved.

The rotary impact tool including the aforementioned rotation number range determination device may also be configured as below. Specifically, the rotary impact tool may include at least one of a voltage detection device configured to detect a voltage of a power source for supplying power to the motor, and a rotation direction detecting device configured to detect whether a rotation direction of the motor is a predetermined forward rotation direction or a reverse rotation direction; and a rotation number range setting device configured to set the rotation number range based on a detection result by at least one of the voltage detection device and the rotation direction detecting device.

The rotation speed of the motor may be changed in accordance with changes in the power source voltage, and may also be changed depending on whether the rotation direction of the motor is the forward rotation direction or the reverse rotation direction. Accordingly, by setting the rotation number range based on the power source voltage or the rotation direction of the motor, it is possible to set a more appropriate rotation number range depending on a state of use of the tool, and thus is possible to achieve a further increased accuracy in detection of an impact.

There may be various manners in which the rotation number range setting device specifically sets the rotation number range based on the power source voltage or the rotation direction of the motor. For example, the rotation number range may be set such that the rotation number range is in a region of higher rotation numbers as the voltage detected by the voltage detection device is larger. Also, in a case where one of the rotation speed in the forward rotation direction and the rotation speed in the reverse rotation direction is relatively higher than the other rotation speed, the rotation number range may be set such that the rotation number range is in a region of higher rotation numbers in the case of the rotation direction with the higher rotation speed.

With such configuration, it is possible to set an appropriate rotation number range with the power source voltage or the rotation direction considered.

It may be possible to variably set the first threshold value and the second threshold value in a same manner as the aforementioned rotation number range. Specifically, the rotary impact tool may include at least one of a voltage detection device configured to detect a voltage of a power source for supplying power to the motor, and a rotation direction detecting device configured to detect whether a rotation direction of the motor is a predetermined forward rotation direction or a reverse rotation direction; and a threshold value setting device configured to set the threshold value based on a detection result by at least one of the voltage detection device and the rotation direction detecting device.

The extreme value difference of the extreme value pair when application of an impact is being applied may be changed depending on the power source voltage or the rotation direction. Accordingly, by setting the threshold value based on the power source voltage or the rotation direction of the motor as described above, it is possible to set a more appropriate threshold value depending on a state of use of the tool, and thus is possible to achieve a further increased accuracy in detection of an impact.

There may be various manners in which the threshold value setting device specifically sets the threshold value based on the power source voltage or the rotation direction of the motor. For example, the threshold value may be set such that the threshold value becomes smaller as the voltage detected by the voltage detection device is larger. Also, in a case where one of the rotation speed in the forward rotation direction and the rotation speed in the reverse rotation direction is relatively higher than the other rotation speed, the threshold value may be set such that the threshold value is smaller in the case of the rotation direction with the higher rotation speed.

With such configuration, it is possible to set an appropriate threshold value with the power source voltage or the rotation direction considered.

The rotary impact tool in the present invention as described above is preferably includes a first rotation speed restriction device that is configured to restrict the rotation speed of the motor when it is detected by the impact detection device that the impact force is being applied. The restriction here may mean not only to reduce the rotation speed but also to stop the rotation.

According to the rotary impact tool with such configuration, detection of an impact may be performed highly accurately and promptly. Also, it is possible to promptly restrict the rotation speed of the motor. It is, therefore, possible to suppress adverse effects, such as stripping or damaging a screw head as mentioned above, which may be caused by an excessive torque when an impact is applied, on a target object for which the rotary impact tool is used.

Intended use of the rotary impact tool of the present invention may be not only connecting a target object to an opponent member, such as tightening a screw, but also separating a target object from an opponent member, such as loosening and removing a screw from a member to which the screw is tightened. In such case, it is not necessarily required to reduce the rotation speed while an impact is applied, but it is preferable to reduce the rotation speed after the impact is terminated, in order to avoid the target object, such as a screw, from falling off at once from the opponent member.

Accordingly, the rotary impact tool of the present invention may further include: a rotation direction detecting device configured to detect whether a rotation direction of the motor is a predetermined forward rotation direction or a reverse rotation direction; an impact termination determination device configured to determine, when it is detected by the rotation direction detecting device that the rotation direction is the reverse rotation direction and it is also detected by the impact detection device that the impact force is being applied, whether or not application of the impact force has been terminated; and a second rotation speed restriction device configured to restrict the rotation speed of the motor when it is determined by the impact termination determination device that application of the impact force has been terminated.

With such configuration, it is possible, when removing the target object of the tool from the opponent member by reversely rotating the motor, to suppress the target object from falling off at once, and thereby avoid reduction in working performance.

In a case where the rotary impact tool of the present invention includes a Hall IC configured to output a signal in accordance with a rotational position of the motor, the rotation speed detection device may detect the rotation speed based on the signal outputted from the Hall IC. With such configuration, it is possible to detect the rotation speed with a simple configuration.

### BRIEF DESCRIPTION OF THE DRAWINGS

The present invention will now be described by way of example with reference to the accompanying drawings, in which:

FIG. 1 is a cross-sectional view of a rechargeable impact driver in an embodiment of the present invention;

FIG. 2 is a configuration diagram showing an electric configuration of a motor control unit installed in the rechargeable impact driver;

FIG. 3 is a waveform diagram showing an example of changes in motor rotation number during use (including an impact operation) of the rechargeable impact driver;

FIG. 4 is an enlarged view of a waveform for a predetermined time period in a no-load state (a load is smaller than a predetermined value), in which application of an impact is not performed, in the waveform diagram of FIG. 3;

FIG. 5 is an enlarged view of a waveform for a predetermined time period in which a load of a predetermined value or more is exerted and application of an impact is performed in the waveform diagram of FIG. 3;

FIG. 6 is a flowchart showing an impact control process executed by a controller;

FIGS. 7A-7B are flowcharts showing details of an impact detection process of S170 in the impact control process in FIG. 6;

FIG. 8 is a flowchart showing details of a re-determination process of S450 in the impact detection process in FIGS. 7A-7B; and

FIG. 9 is a waveform diagram showing another example of changes in motor rotation number (an example of changes in a case of loosening a screw by a reverse rotation).

### DETAILED DESCRIPTION OF THE PREFERRED EMBODIMENTS

Since a more specific structure (particularly an impact mechanism) of a rechargeable impact driver 1 (hereinafter referred to as the “impact driver 1”) is detailedly disclosed in, for example, aforementioned Japanese Unexamined Patent Application Publication No. 2010-207951 and Japanese Unexamined Patent Application Publication No. 2006-218605, further detailed explanation thereof will not be provided here. Instead, a diagrammatic description will be provided of main configurations including an impact mechanism.

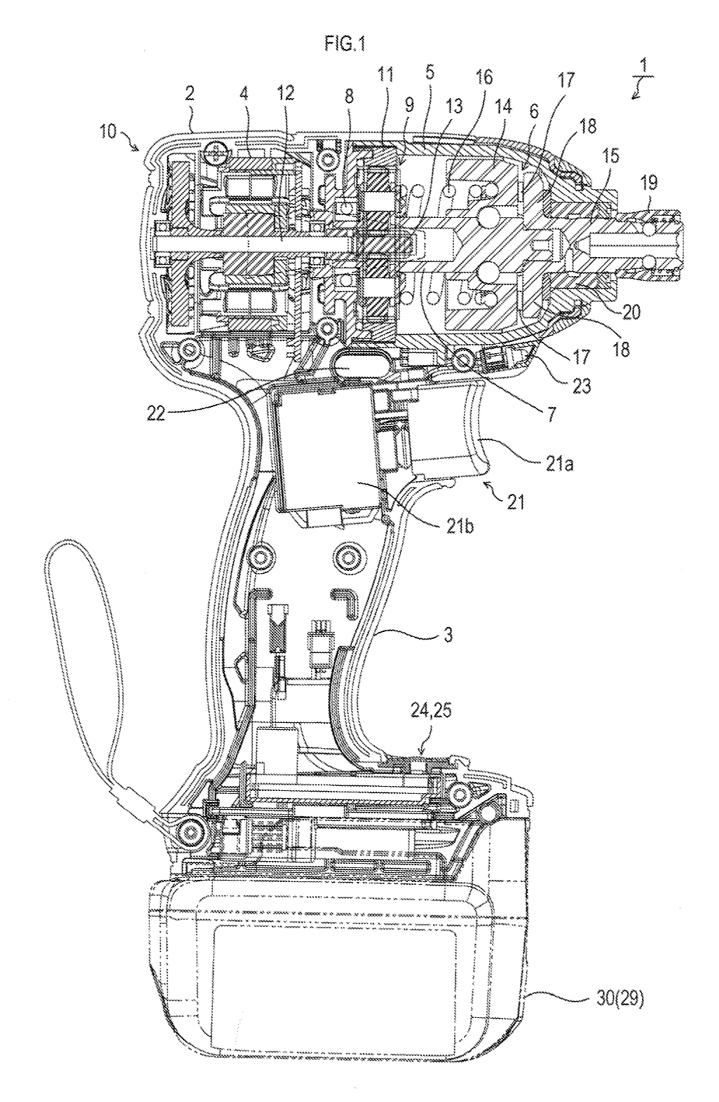

As shown in FIG. 1, the impact driver 1 includes a tool body 10 and a battery pack 30 which supplies electric power to the tool body 10. The tool body 10 includes a housing 2 containing a later-described motor 4 and an impact mechanism 6, and so on, and a grip portion 3 configured to protrude from a lower portion (on a lower side of FIG. 1) of the housing 2.

The housing 2 contains the motor 4 in a rear portion thereof (on a left side of FIG. 1) and a bell-shaped hammer case 5 assembled in front of the motor 4 (on a right side of FIG. 1). The hammer case 5 contains the impact mechanism 6.

The grip portion 3 is designed to be gripped by an operator when using the impact driver 1, and a trigger switch 21 is provided above the grip portion 3. The trigger switch 21 includes a trigger 21a which is pulled by the operator and a switch main body 21b. The switch main body 21b is configured to be turned on/off by a pulling operation of the trigger 21a and to cause a resistance value to change in accordance with an operated amount (a pulled amount) of the trigger 21a.

Also, above the trigger switch 21 (in a lower end portion of the housing 2) is provided a forward and reverse changeover switch 22 (hereinafter referred to as the “changeover switch 22”) which changes over a rotation direction of the motor 4 to one of a forward rotation direction (a clockwise direction when seen frontward from a rear end of the tool, in the present example) and a reverse rotation direction (a rotation direction opposite to the forward rotation direction). An LED 23 for illuminating a forward direction of the impact driver 1 when the trigger 21a is pulled is provided in a lower front portion of the housing 2.

In a front lower part of the grip portion 3, there are provided an impact force setting switch 24 (hereinafter referred to as the “setting switch 24”) for a user to set an impact force (particularly an upper limit value thereof) in a selectable manner from a plurality of levels when applying an impact, and an impact force setting indicator 25 (hereinafter referred to as the “indicator 25”) indicating the impact force set by the impact force setting switch 24.

A battery pack 30 containing a battery 29 is detachably attached to a lower end of the grip portion 3. The battery pack 30 is attached to the lower end of the grip portion 3 by sliding the battery pack 30 from a front side toward a rear side of the grip portion 3. The battery 29 contained in the battery pack 30 is a rechargeable secondary cell, such as a lithium ion secondary cell, in the present embodiment.

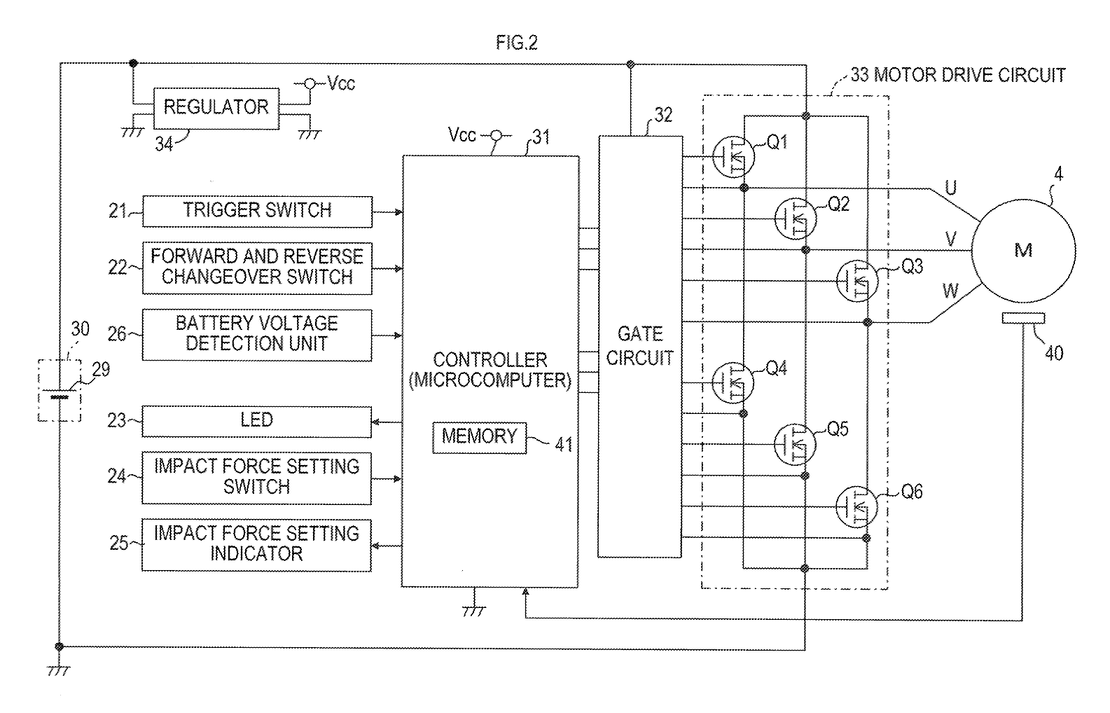

A motor control unit (see FIG. 2), which is omitted in FIG. 1, is installed inside the grip portion 3. The motor control unit, including a controller 31, a gate circuit 32, a motor drive circuit 33, and a regulator 34, is designed to rotate the motor 4 with electric power from the battery pack 30. The motor 4 includes a Hall IC 40 (see FIG. 2), which is omitted in FIG. 1, for detecting a rotational position of the motor 4.

In the housing 2, a spindle 7 having a hollow part at a rear end portion thereof is contained in a hammer case 5. The spindle 7 is disposed coaxially with an output shaft 12 of the motor 4. A ball bearing 8 provided in a rear end portion of the hammer case 5 pivotally supports an outer periphery of the rear end portion of the spindle 7.

In a forward region of the ball bearing 8, there is provided an epicyclic gear mechanism 9 constituted by two epicyclic gears pivotally supported point-symmetrically with respect to a rotation axis. The epicyclic gear mechanism 9 is engaged with an internal gear 11 formed on an inner circumferential surface of the rear end portion of the hammer case 5. The epicyclic gear mechanism 9 is designed to be engaged with a pinion 13 formed at a front end of the output shaft 12 of the motor 4.

The impact mechanism 6 is constituted by the spindle 7, a hammer 14 externally mounted on the spindle 7, an anvil 15 pivotally supported in front of the hammer 14, and a coil spring 16 for forwardly biasing the hammer 14.

The hammer 14 is connected to the spindle 7 in an integrally rotatable and axially movable manner, and is biased forwardly (toward the anvil 15) by the coil spring 16. A front end of the spindle 7 is inserted with a gap into a rear end of the anvil 15 to thereby be pivotally supported in a rotatable manner.

The anvil 15 is designed to be rotated around an axis thereof by receiving a rotational force and an impact force by the hammer 14. The anvil 15 is supported by a bearing 20 provided at a front end of the housing 2 so as to be rotatable around the axis thereof and axially unmovable. At a front end of the anvil 15, there is provided a chuck sleeve 19 for attachment of various tool bits (not shown), such as a driver bit and a socket bit. All of the output shaft 12 of the motor 4, the spindle 7, the hammer 14, the anvil 15, and the chuck sleeve 19 are coaxially arranged.

Two impact projections 17, 17 for applying an impact force to the anvil 15 are projectingly provided on a front end surface of the hammer 14 so as to be mutually spaced apart by 180 degrees in a circumferential direction. Two impact arms 18, 18, which are configured to be abuttable with the impact projections 17, 17 of the hammer 14, are provided in a rear end portion of the anvil 15 so as to be mutually spaced apart by 180 degrees in a circumferential direction. As the hammer 14 is biased and held toward a front end side of the spindle 7 by a biasing force of the coil spring 16, the impact projections 17, 17 of the hammer 14 abut the impact arms 18, 18 of the anvil 15.

In such a state as above, when the spindle 7 is rotated by a rotational force of the motor 4 through the epicyclic gear mechanism 9, the hammer 14 is rotated together with the spindle 7, and a rotational force of the hammer 14 is transmitted to the anvil 15 through the impact projections 17, 17 and the impact arms 18, 18. As a result, a driver bit or the like attached to the front end of the anvil 15 is rotated, and tightening of a screw becomes possible.

When the screw is tightened to a predetermined position and thereby an external torque of a predetermined value or more is applied to the anvil 15, a rotational force (torque) of the hammer 14 against the anvil 15 also becomes a predetermined value or more. As a result, the hammer 14 is moved rearward against the biasing force of the coil spring 16, and the impact projections 17, 17 of the hammer 14 ride over the impact arms 18, 18 of the anvil 15. Then, the impact projections 17, 17 of the hammer 14 depart from the impact arms 18, 18 of the anvil 15 and spin around. Once the impact projections 17, 17 of the hammer 14 ride over the impact arms 18, 18 of the anvil 15, the hammer 14 is moved forward again by the biasing force of the coil spring 16, while being rotated together with the spindle 7, and the impact projections 17, 17 of the hammer 14 apply an impact on the impact arms 18, 18 of the anvil 15 in a rotation direction.

Accordingly, each time a torque of the predetermined value or more is applied to the anvil 15, an impact by the hammer 14 is repeatedly applied to the anvil 15. Such intermittent application of an impact force of the hammer 14 on the anvil 15 allows screw retightening at a high torque.

Next, a description will be provided with reference to FIG. 2 on a motor control unit provided inside the impact driver 1 in order to control rotational driving of the motor 4.

As shown in FIG. 2, the impact driver 1 includes a battery 29, a controller 31, a gate circuit 32, and a motor drive circuit 33, as a motor control unit to control driving of the motor 4. The motor 4 is a three-phase brushless motor having armature windings of respective phases U, V, and W in the present embodiment.

The motor drive circuit 33 is designed to receive supply of a specified DC voltage (for example, 14.4 V) from the battery 29, and to transmit electric current to the windings of the respective phases of the motor 4. The motor drive circuit 33 is a three-phase full-bridge circuit constituted by six switching devices Q1 to Q6 in the present embodiment. Each of the switching devices Q1 to Q6 is a MOSFET in the present embodiment.

In the motor drive circuit 33, three switching devices Q1 to Q3 are provided, as so-called high side switches, between respective terminals U, V, and W of the motor 4 and a power source line connected to a positive electrode of the battery 29. Also, the other three switching devices Q4 to Q6 are provided, as so-called low side switches, between the respective terminals U, V, W of the motor 4 and a ground line connected to a negative electrode of the battery 29.

The gate circuit 32 is designed to turn on/off the switching devices Q1 to Q6 in the motor drive circuit 33 in accordance with a control signal outputted from the controller 31, to thereby flow current to the windings of the respective phases in the motor 4 and rotate the motor 4.

The controller 31 is constituted, by way of example, as a so-called one chip microcomputer in the present embodiment. The controller 31 includes a memory 41, a CPU, an input/output (I/O) port, an A/D converter, a timer, and others. The memory 41 may be a ROM, a RAM, and a rewritable non-volatile memory device (such as a flash ROM, an EEPROM, or the like). The CPU executes various processes in accordance with various programs stored in the memory 41.

The trigger switch 21 (more specifically, the switch main body 21b), the changeover switch 22, the LED 23, the setting switch 24, the indicator 25, and a battery voltage detection unit 26 (hereinafter referred to as the “detection unit 26”) are connected to the controller 31. The Hall IC 40 provided in the motor 4 is also connected to the controller 31.

The controller 31 sets respective drive duty ratios for the switching devices Q1 to Q6 constituting the motor drive circuit 33 in accordance with a drive command from the trigger switch 21, and outputs control signals in accordance with the respective drive duty ratios to the gate circuit 32, to thereby rotate the motor 4.

The controller 31 in the present embodiment controls rotation of the motor 4 such that a rotation number of the motor 4 corresponds to a pulled amount (an operation amount) of the trigger 21a by an user with a predetermined maximum rotation number corresponding to an impact force selected by the setting switch 24 as an upper limit value. The rotation number here means a number of rotations per unit time, and thus means substantially the same as a rotation speed.

When the trigger 21a constituting the trigger switch 21 is pulled, a signal corresponding to the pulled amount is inputted to the controller 31 from the switch main body 21b also constituting the trigger switch 21. Then, the controller 31 controls the motor 4 such that the motor 4 is rotated at the rotation number corresponding to the pulled amount in accordance with the inputted signal (the signal corresponding to the pulled amount).

In the present embodiment, it is configured such that the rotation number in a case of reverse rotation is larger than the rotation number in a case of forward rotation even for a same pulled amount.

Although the description hereinafter will be provided based on such configuration, the configuration is merely an example. A configuration may be employed such that the rotation number in the case of forward rotation is larger than the rotation number in the case of reverse rotation, or a configuration may be employed such that the rotation numbers in both rotation directions are the same.

The controller 31 controls the rotation number using a signal from the Hall IC 40. The Hall IC 40 is a known rotation sensor provided with a Hall device. Specifically, the Hall IC 40 is configured to output a pulse signal each time a rotational position of a rotor of the motor 4 has reached a predetermined rotational position (i.e., each time the motor 4 has been rotated by a predetermined amount).

The controller 31 calculates the rotational position and the rotation number of the motor 4 based on the pulse signal from the Hall IC 40, and controls the motor 4 through the gate circuit 32 and the motor drive circuit 33 such that the calculated rotation number is coincident with a set rotation number determined in accordance with the pulled amount of the trigger 21a.

Actually, the rotation number of the motor 4 irregularly fluctuates in a high-frequency range (for example, in a range of frequencies of twice or more a rotational frequency of a tool bit). Accordingly, if the rotation number is calculated based on the pulse signal from the Hall IC 40, the calculated rotation number includes a high-frequency fluctuation component which is an irregularly fluctuating component. Use of such rotation number including the high-frequency fluctuation component may be an obstacle to various controls with high accuracy.

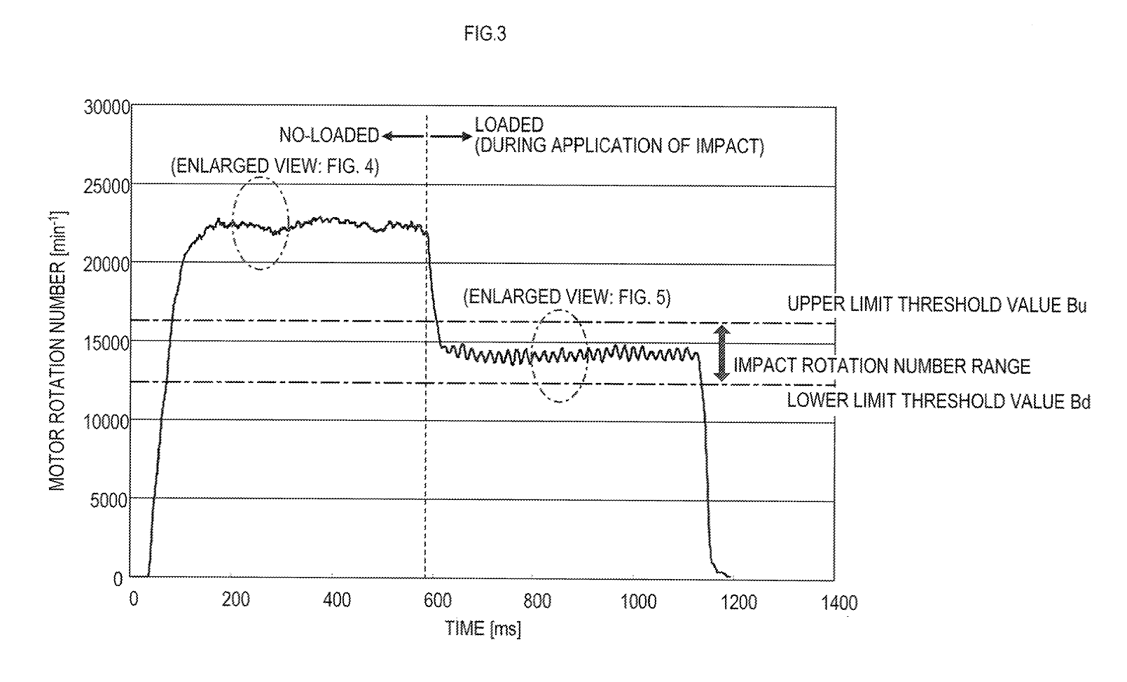

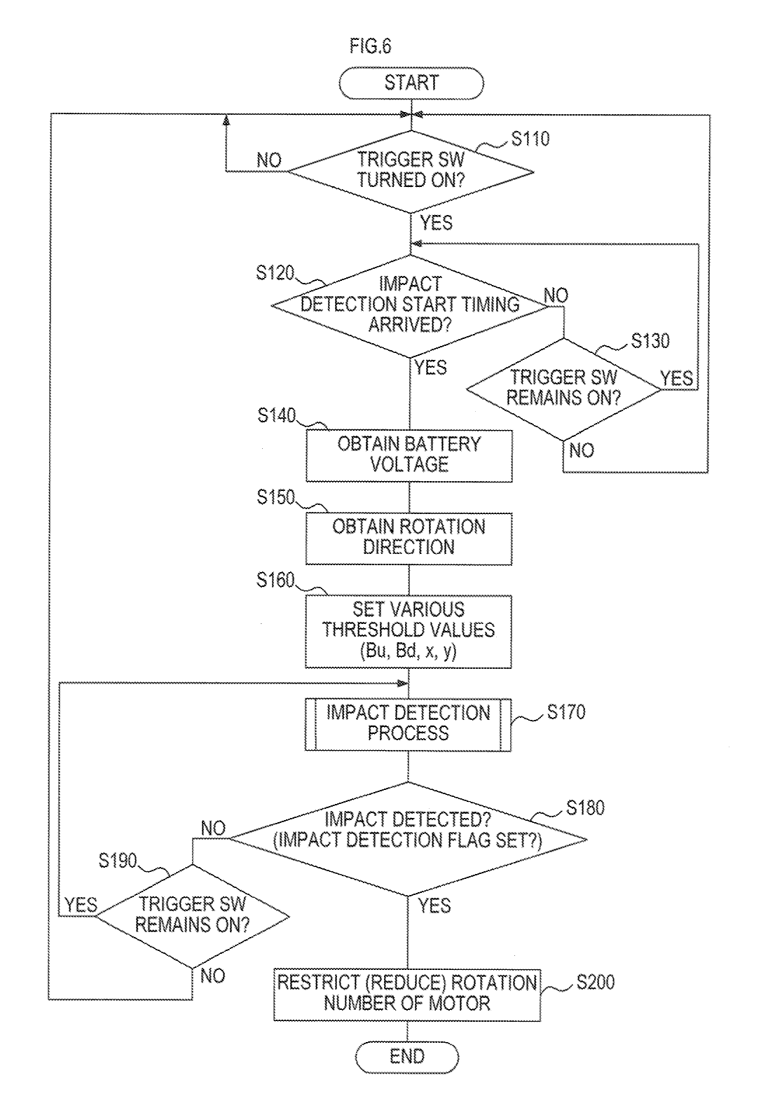

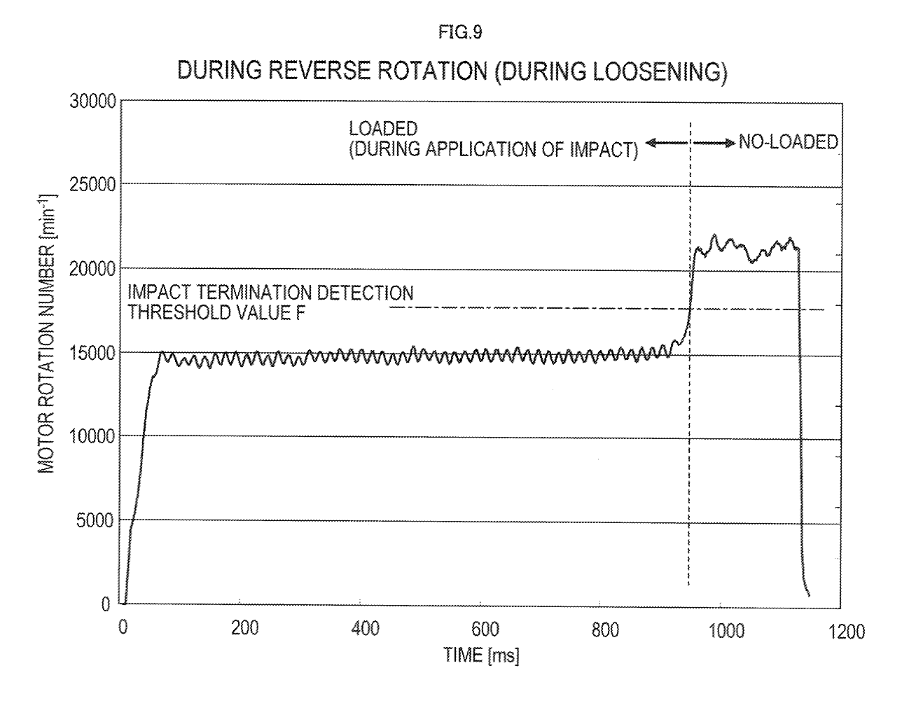

In view of the above, the controller 31 in the present embodiment performs a predetermined averaging process of the rotation number (including the high-frequency fluctuation component) calculated based on the pulse signal from the Hall IC 40 to obtain a rotation number after removing the high-frequency fluctuation component (that is, an averaged rotation number). Then, based on the obtained rotation number (the averaged rotation number), various control processes, including the aforementioned rotation control and an after-mentioned impact control process (FIG. 6), are performed. All waveform diagrams (described in detail later) of the rotation numbers of the motor 4 shown in FIG. 3 to FIG. 5, and FIG. 9 represent the rotation numbers after the averaging process is performed, which are to be actually used by the controller 31 in the various control processes.

Although the averaging process in the present embodiment is performed by means of software processing (for example, by time averaging calculation) in the controller 31, this is merely an example. There may be various specific methods for the averaging process. For example, it may be possible to remove the high-frequency component using a low-pass filter. Also, it is not necessarily required to perform the averaging process as above. For example, in a case where the high-frequency fluctuation component is at an ignorable level, it may be possible to simply use the rotation number calculated based on the pulse signal from the Hall IC 40 for various control processes.

The controller 31 rotates the motor 4 in a rotation direction set by the changeover switch 22 based on a rotation direction setting signal from the changeover switch 22. Also, the controller 31 performs a control of lighting the LED 23 while the trigger 21a is pulled and a control of indicating an impact force set by the setting switch 24 on the indicator 25.

The detection unit 26 detects a voltage of the battery 29, and outputs a voltage detection signal indicating the detected voltage value to the controller 31. The controller 31 detects the voltage of the battery 29 (the battery voltage) based on the voltage detection signal from the detection unit 26, and uses the battery voltage in various control processes, such as a later-described impact control process (FIG. 6).

The controller 31 constituted by a microcomputer requires supply of a constant power source voltage Vcc. Accordingly, in the housing 2 of the impact driver 1, there is also provided a regulator 34 which generates the constant power source voltage Vcc (for example, DC 5 V) receiving power supply from the battery 29.

Next, a specific description will be provided of an impact control process. In the impact control process, the controller 31 detects an impact and restricts (for example, reduces) the rotation number of the motor 4. The impact control process is one of the various control processes to be executed by the controller 31 in order to rotate the motor 4 in accordance with the drive command from the trigger switch 21. First, an overview of the impact control process will be provided with reference to the waveform diagrams of FIG. 3 to FIG. 5.

FIG. 3 shows an example of changes in motor rotation number during a series of tightening operation with the impact driver 1 of the present embodiment. The series of tightening operation is specifically an operation of turning on the trigger switch 21 (that is, pulling the trigger 21a) to start tightening of a screw, applying an impact force for a certain period of time after the screw is seated to thereby additionally tighten the screw, and then turning off the trigger switch 21.

As shown in FIG. 3, during a time period from when rotation of the motor 4 is started (that is, when tightening of the screw is started) until the screw is seated, the motor 4 is in a no-load state and rotates at a high speed with a rotation number of approximately 22,500 per minute. The “load” as used here means a load torque externally applied to a tool bit, in other words, a rotational torque required to rotate the tool bit (rotate the chuck sleeve 19). Also, the “no-load state” as used here means a state where a load (a rotational torque) is smaller than a predetermined value and therefore application of an impact is not performed.

When tightening of the screw proceeds and the screw is seated on a target object member of tightening, the load is increased. Eventually, the rotational torque exceeds the predetermined value, and application of an impact is started. Since the load (the rotational torque) is large during the application of the impact, rotation is performed with the rotation number of approximately 14,000 per minute which is smaller than in the no-load state. When an impact force is exerted for a certain time period after starting the application of the impact and then the trigger switch 21 is turned off, the rotation of the motor 4 is stopped.

In the present embodiment, a predetermined impact rotation number range is set as one of determination criteria for impact detection in order to detect an impact in a highly accurate manner. Specifically, a lower limit threshold value Bd indicating a lower limit value of the range and an upper limit threshold value Bu indicating an upper limit value of the range are set. Also, one of conditions to detect an impact is that the rotation number of the motor 4 is within the impact rotation number range.

FIG. 4 is an enlarged view of a waveform in a no-load state where application of an impact is not performed. More specifically, this is an enlarged view of a waveform in a time period of 200 to 300 minutes after the trigger switch 21 is turned on.

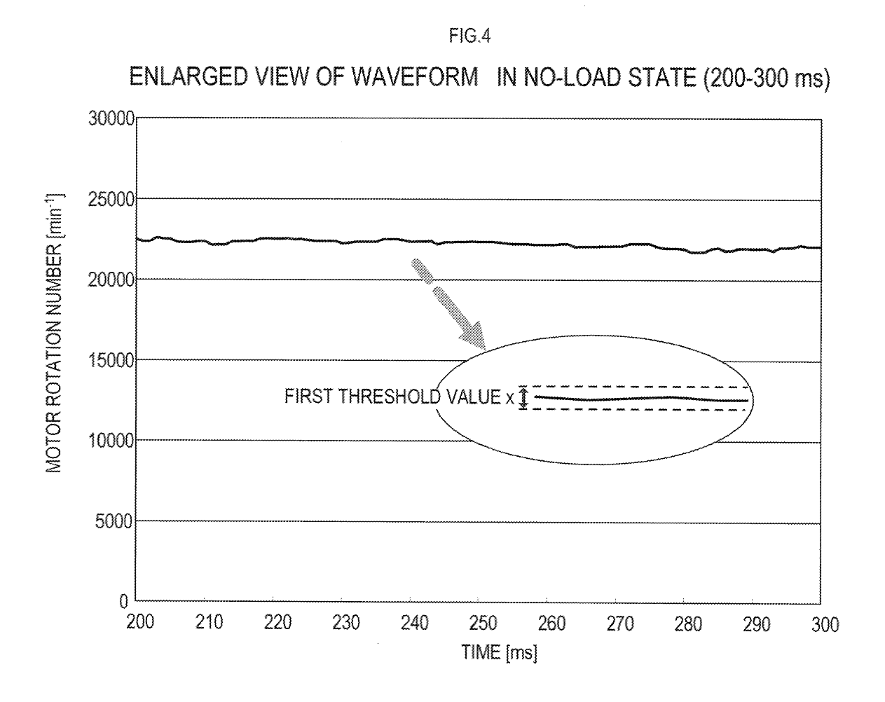

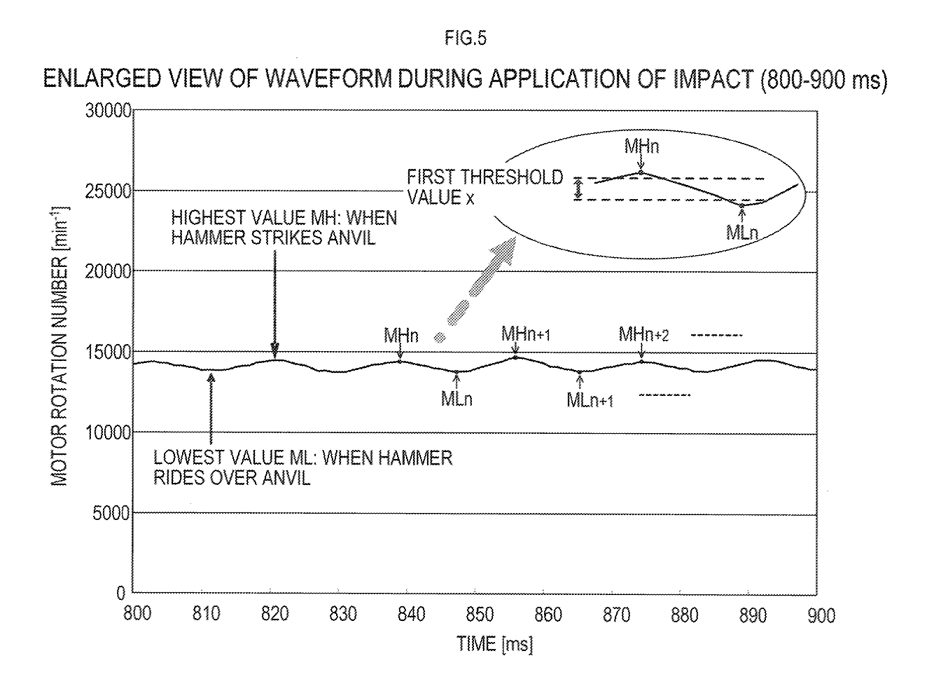

FIG. 5 is an enlarged view of a waveform while application of an impact is performed. More specifically, this is an enlarged view of a waveform for a time period of 800 to 900 minutes after the trigger switch 21 is turned on.

In the no-load state, as clearly shown in FIG. 4, the motor 4 rotates at a high speed with the rotation number of approximately 22,500 per minute and with little change in rotation number. In contrast, while an impact is applied, as clearly shown in FIG. 5, the rotation number of the motor 4 periodically changes due to an impact operation. Specifically, the rotation number of the motor periodically changes in synchronization with a rotation of the hammer 14.

During application of an impact, when the hammer 14 rides over the anvil 15 (after riding over the anvil 15 and immediately before leaving the anvil 15), the rotation number of the motor 4 becomes a lowest value ML. On the other hand, when the hammer 14 strikes against the anvil 15 again after once leaving the anvil 15 (specifically immediately before an impact force is applied), the rotation number of the motor 4 becomes a highest value MH. Accordingly, during application of an impact, each time the hammer 14 is rotated, the rotation number of the motor 4 changes in synchronization with the rotation of the hammer 14, and a timing of reaching the lowest value ML and a timing of reaching the highest value MH arrive alternately.

If strictly defined in mathematical term, the aforementioned lowest value ML in the periodically changing waveform is a minimum value and the aforementioned highest value MH is a maximum value. Therefore, in the rotation number of the motor during application of an impact, the maximum value and the minimum value alternately occur.

However, in the present embodiment, the maximum value and the minimum value of the motor rotation number which occur during application of an impact are referred to as the highest value and the lowest value, respectively, as mentioned above for explanation purposes. That is, in the present embodiment, the highest value (MH) corresponds to the maximum value of the present invention and the lowest value (ML) corresponds to the minimum value of the present invention.

As described above, in the motor rotation number during application of an impact, the lowest value (ML) and the highest value (MH) occur alternately in chronological order. Accordingly, the controller 31 in the present embodiment chronologically sequentially detects the highest value (MH) and the lowest value (ML) of the rotation number of the motor 4 during the rotation thereof, in order to detect an impact. Any of the highest value (MH) and the lowest value (ML) may be detected earlier. When a difference between the sequentially detected highest value (MH) and lowest value (ML) is equal to or more than a first threshold value x, it is determined that application of an impact is performed.

A specific description will be provided with reference to FIG. 5. To illustrate a principle of impact detection, the description is provided on an assumption that application of an impact is started at or after the timing of 830 ms in the waveform of FIG. 5 for convenience. In this case, the highest value (MHn) is first detected at a timing of about 839 ms after a starting of an impact, and subsequently the lowest value (MLn) is detected at a timing of about 847 ms. Then the controller 31 performs calculation of the difference between the sequentially detected highest value MHn and lowest value MLn. If the difference between the values is equal to or more than the first threshold value x, it is determined that application of an impact is applied.

In the present embodiment, it may be possible to detect an impact by making a plurality of determinations (two determinations in the present example) instead of only one determination as described above. Also, it may be possible to make a re-determination if the aforementioned difference is not equal to or more than the first threshold value x. These various control methods will be described later.

As mentioned above, the rotation number of the motor periodically changes, and the highest value and the lowest value periodically occur during application of an impact. It is, therefore, possible to detect an impact by appropriately setting the first threshold value x.

In the no-load state where application of an impact is not performed, the first threshold value x is appropriately set to a value such that a fluctuation range of the motor rotation number does not exceed the first threshold value x (see FIG. 4). Also, while application of an impact is performed, the first threshold value x is appropriately set to a value such that the fluctuation range (that is, a difference between the highest value and the lowest value) of the motor rotation number exceeds the first threshold value x (see FIG. 5). However, if the first threshold value x is set such that the fluctuation range always exceeds the first threshold value x considering a possible difference which occurs during application of an impact, the first threshold value x may be an extremely low value, which may lead to a misdetection of an impact even in the no-load state. Therefore, the first threshold value x should be set to an appropriately high value in order to avoid a misdetection of an impact in the no-load state.

Next, a description will be provided of an impact control process executed by the controller 31 along the flowcharts shown in FIGS. 6 to 8. The impact control process is a process to achieve the aforementioned detection of an impact and restriction of the motor rotation number after the detection of an impact.

The impact control process shown in FIG. 6 is repeatedly executed by the controller 31 while the power source voltage Vcc is applied from the regulator 34 to the controller 31.

As shown in FIG. 6, when starting the impact control process, the controller 31 first determines in S110 whether or not the trigger switch 21 is turned on. The processing in S110 is repeated while the trigger switch 21 is turned off. When the trigger switch 21 is turned on (S110: YES), it is determined in S120 whether or not an impact detection start timing has arrived. Specifically, it is determined whether or not a predetermined time has elapsed since the trigger switch 21 was turned on. Waiting for elapse of the predetermined time is to avoid misdetection of an impact under an unstable condition immediately after the trigger switch 21 is turned on.

Until the impact detection start timing has arrived (that is, until the predetermined time has elapsed since the trigger switch 21 was turned on) the present process proceeds to S130 and it is determined whether or not the trigger switch 21 remains on. As long as the trigger switch 21 remains on (S130: YES), the process returns to S120. When the trigger switch 21 is turned off (S130: NO) the process returns to S110.

When it is determined that the impact detection start timing has arrived (S120: YES), a battery voltage is obtained from the detection unit 26 in S140. Also in S150, a rotation direction of the motor 4 is obtained based on a signal from the changeover switch 22. Then, in S160, the upper limit threshold value Bu, the lower limit threshold value Bd, the first threshold value x, and a second threshold value y are set based on the obtained battery voltage and rotation direction.

The upper limit threshold value Bu and the lower limit threshold value Bd are set as follows: With respect to the battery voltage, the upper limit threshold value Bu and the lower limit threshold value Bd are set to respective larger values as the battery voltage becomes larger. In other words, the upper limit threshold value Bu and the lower limit threshold value Bd are set such that the impact rotation number range is, as a whole, in a region of higher rotation numbers as the battery voltage becomes larger. Also, as described above, the rotation number in the case of reverse rotation is larger than the rotation number in the case of forward rotation in the present embodiment. Accordingly, the upper limit threshold value Bu and the lower limit threshold value Bd are set so as to be larger in the reverse rotation than in the forward rotation. In other words, the upper limit threshold value Bu and the lower limit threshold value Bd are set such that the impact rotation number range is, as a whole, in a region of higher rotation numbers in the case of reverse rotation than in the case of forward rotation.

The first threshold value x and the second threshold value y are basically set such that the second threshold value y is smaller than the first threshold value x. On such basis, the first threshold value x and the second threshold value y are set in accordance with the battery voltage and the rotation direction.

With respect to the battery voltage, the first threshold value x and the second threshold value y are set to be smaller as the battery voltage becomes larger. With respect to the rotation direction, the first threshold value x and the second threshold value y are set to be smaller in the case of reverse rotation than in the case of forward rotation.

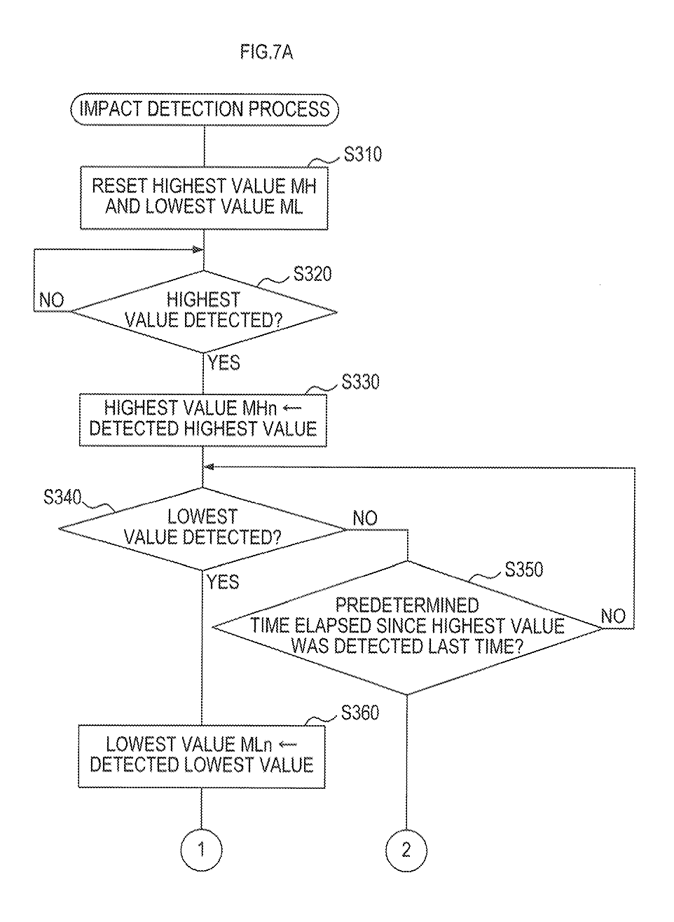

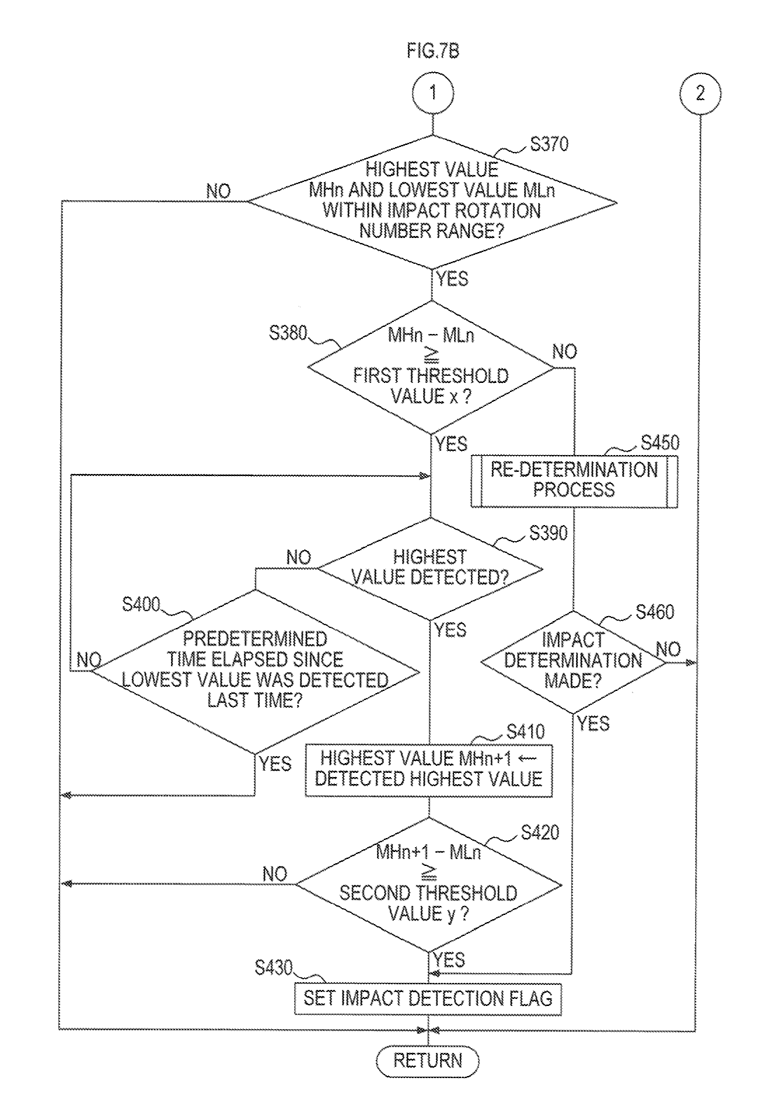

After setting the first threshold value x and the second threshold value y as described above, the process proceeds to an impact detection process in S170. The details of the impact detection process in S170 are shown in FIGS. 7A-7B. When the process proceeds to the impact detection process, first in S310, the highest value MH and the lowest value ML stored in the memory 41 are all reset. Then, in S320, it is determined whether or not a highest value is detected.

The detection of the highest value in S320 is substantially a processing to detect a maximum value. Specifically, a comparison is made between a rotation number calculated by the controller 31 in a determination processing in S320 last time and a rotation number calculated by the controller 31 in the determination processing in S320 this time (that is, currently), and when a value this time is smaller than a value last time (that is, in a case of change from increase to decrease) the value last time is detected as the highest value.

When the highest value is detected in S320, the detected highest value is stored in the memory 41 as a highest value MHn in S330. Then in S340, it is determined whether or not a lowest value is detected.

The detection of the lowest value in S340 is substantially a processing to detect a minimum value. Specifically, a comparison is made between a rotation number calculated by the controller 31 in a determination processing in S340 last time and a rotation number calculated by the controller 31 in the determination processing in S340 this time (that is, currently), and when a value this time is larger than a value last time (that is, in a case of change from decrease to increase) the value last time is detected as the lowest value.

If the lowest value is not detected in a lowest value detection processing in S340, the process proceeds to S350, and it is determined whether or not a predetermined time has elapsed since the highest value was detected last time (that is, since the highest value was detected in S320).

If it is determined that the predetermined time has not elapsed (S350: NO), the process returns to S340 and detection of the lowest value is continued. If it is determined that the predetermined time has elapsed before the lowest value is detected (S350: YES), the impact detection process is terminated, and the process proceeds to S180 (FIG. 6). If the lowest value is detected before the predetermined time has elapsed (S340: YES), the detected lowest value is stored in the memory 41 as a lowest value MLn in S360.

In S370, it is determined whether or not the highest value MHn and the lowest value MLn stored in the memory 41 in S330 and S360, respectively, are both within the impact rotation number range (that is, equal to or lower than the upper limit threshold value Bu and also equal to or higher than the lower limit threshold value Bd) (see FIG. 3). If any of the highest value MHn and the lowest value MLn is beyond the impact rotation number range (S370: NO), the impact detection process is terminated, and the process proceeds to S180 (FIG. 6). If both of the highest value MHn and the lowest value MLn are within the impact rotation number range (S370: YES), the process proceeds to S380.

In S380, it is determined whether or not a difference between the highest value MHn and the lowest value MLn (hereinafter also referred to as a “first difference”) is equal to or more than the first threshold value x. If the first difference is equal to or more than the first threshold value x (S380: YES), a tentative determination is made that there is a high possibility that application of an impact is being performed, and a further same determination is performed subsequently. Specifically, in S390, detection of a highest value as a next maximum value is performed again. That is, since the highest value MHn and the lowest value MLn have been sequentially detected at present, detection of a highest value which should occur again next time is performed. The highest value detection processing in S390 is completely the same as in S320.

If the highest value is not detected in the highest value detection processing of S390, the process proceeds to S400, and it is determined whether or not a predetermined time has elapsed since the lowest value was detected last time (that is, since the lowest value was detected in S340). If it is determined that the predetermined time has not yet elapsed (S400: NO), the process returns to S390 and the highest value detection processing is continued. If it is determined that the predetermined time has elapsed before a highest value is detected (S400: YES), the impact detection process is terminated, and the process proceeds to S180 (FIG. 6). If a highest value is detected before the predetermined time has elapsed (S390: YES), the detected highest value is stored in the memory 41 as a highest value MHn+1 in S410, and the process proceeds to S420.

In S420, it is determined whether or not a difference between the highest value MHn+1 and the lowest value MLn (hereinafter also referred to as a “second difference”) is equal to or more than the second threshold value y which is smaller than the first threshold value x. If the second difference is smaller than the second threshold value y, the impact detection process is terminated without making a determination that application of an impact is being performed and the impact detection process is terminated, and the process proceeds to S180 (FIG. 6). If the second difference is equal to or more than the second threshold value y (S420: YES), a confirmation determination is made that application of an impact is being performed, and an impact detection flag is set in the memory 41 in S430.

That is, even when the difference (the first difference) between the highest value MHn and the lowest value MLn is equal to or more than the first threshold value x in S380, only the tentative determination is made without making the confirmation determination that application of an impact is being performed, and subsequently the confirmation determination is made that application of an impact is being performed after confirming that the difference (the second difference) between the subsequent highest value MHn+1 and the lowest value MLn is equal to or more than the second threshold value y.

If it is determined in S380 that the difference (the first difference) between the highest value MHn and the lowest value MLn is smaller than the first threshold value x (S380: NO), the process proceeds to S450, and a re-determination process is performed.

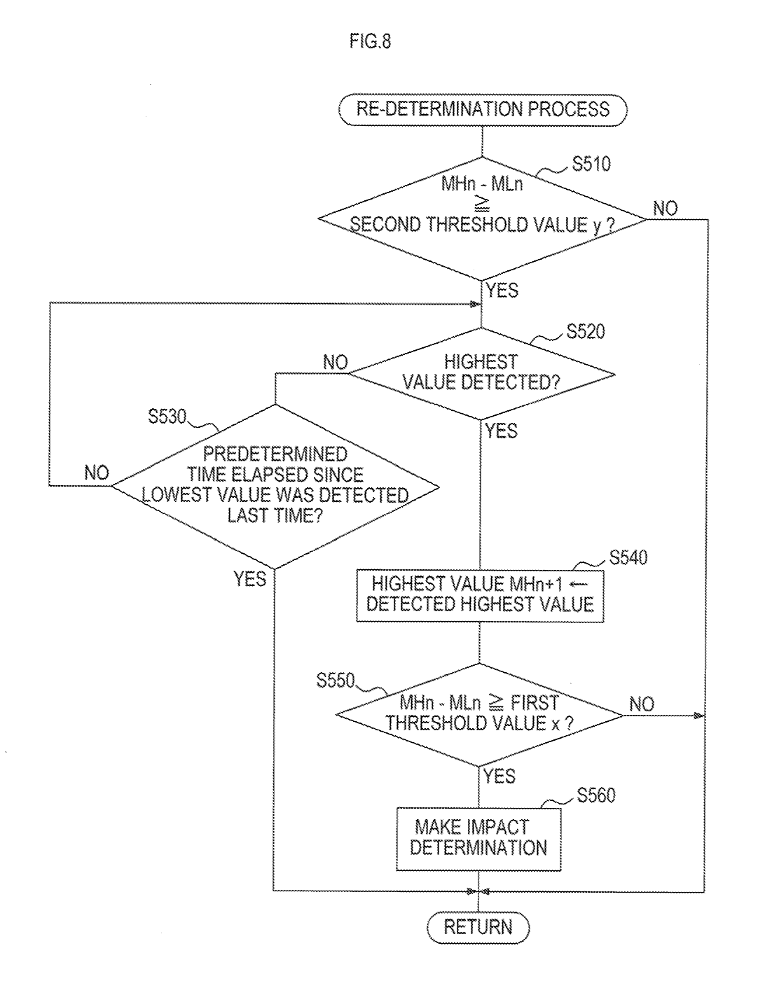

The details of the re-determination process in S450 are shown in FIG. 8. When the process proceeds to the re-determination process, it is first determined in S510 whether or not the difference (the first difference) between the highest value MHn and the lowest value MLn is equal to or more than the second threshold value y. If the first difference is smaller than the second threshold value y (S510: NO), it is determined that application of an impact is not performed and the re-determination process is terminate. Then, the process proceeds to S460 (see FIG. 7B).

On the other hand, if the first difference is equal to or more than the second threshold value y (S510: YES), a tentative determination is made that there is a high possibility that application of an impact is being performed, and the determination based on the first threshold value x is performed again. Specifically, in S520, a detection processing of a highest value as a next maximum value is performed in a same manner as in S390 of FIG. 7B. If a highest value is not detected even in the detection processing in S520, the process proceeds to S530, and it is determined whether or not a predetermined time has elapsed since the lowest value was detected last time in a same manner as in S400. If it is determined that the predetermined time has not yet elapsed (S530: NO), the process returns to S520. If it is determined that the predetermined time has elapsed before a highest value is detected (S530: YES), it is determined that application of an impact is not performed, and the re-determination process is terminated. If a highest value is detected before the predetermined time has elapsed (S520: YES), the detected highest value is stored in the memory 41 as a highest value MHn+1 in S540, and the process proceeds to S550.

In S550, it is determined whether or not the difference (the second difference) between the highest value MHn+1 and the lowest value MLn is equal to or more than the first threshold value x. If the second difference is equal to or more than the first threshold value x (S550: YES), an impact determination, that is, a confirmation determination that application of an impact is being performed is made in S560, and the re-determination process is terminated. If it is determined in S550 that the second difference is smaller than the first threshold value x (S550: NO), it is determined that application of an impact is not performed, and the re-determination process is terminated.

Returning to FIG. 7B, when the re-determination process in S450 is terminated, the process proceeds to S460, and it is determined whether or not an impact determination is made in the re-determination process in S450 (whether or not an impact determination is made in the re-determination process of S560 shown in FIG. 8). If an impact determination is not made in the re-determination process in S450 (S460: NO), the impact detection process is immediately terminated, and the process proceeds to S180 (see FIG. 6). If an impact determination is made in the re-determination process in S450 (S460: YES), an impact detection flag is set in the memory 41 in S430, and the impact detection process is terminated. Then, the process proceeds to S180.

Returning to FIG. 6, when the impact detection process is S170 is terminated and the process proceeds to S180, it is determined whether or not an impact has been detected in the impact detection process in S170 (whether or not an impact detection flag is set in the memory 41). If an impact detection flag is set (S180: YES), the process proceeds to S200, and the rotation number of the motor 4 is restricted (reduced). Specific examples of restriction of the rotation number may be in various forms. For example, rotation of the motor 4 may be completely stopped.

If an impact detection flag is not set (S180: NO), the process proceeds to S190, and it is determined whether or not the trigger switch 21 remains on in a same manner as in S130. If the trigger switch 21 remains on (S190: YES), the process returns to S170. If the trigger switch 21 is turned off (S190: NO), the process returns to S110.

As described above, in the impact driver 1 of the present embodiment, the controller 31 calculates the rotation number of the motor 4 based on the pulse signal from the Hall IC 40, and presence or absence of an impact is detected based on the calculated rotation number. Specifically, the difference between the highest value MH and the lowest value ML of the rotation number, which occur chronologically sequentially, is calculated, and it is determined whether or not application of an impact is being performed based on whether or not the difference is equal to or more than the first threshold value x. That is, detection of all impact is performed using the periodical changes in rotation speed occurring while application of an impact is performed. Therefore, detection of an impact can be performed highly accurately and rapidly even with a simple configuration.

When an impact is detected, the rotation number of the motor 4 is restricted, for example, by reducing the rotation number of the motor 4 or stopping the motor 4, so that the rotation number will be at least lower than the rotation number before the impact is detected.

Accordingly, it is possible during a screw tightening operation to detect an impact immediately after the screw is seated (immediately after application of an impact is started) and to restrict the rotation number of the motor 4. Thus, it is possible to suppress troubles such as stripping or damaging the screw head.

Also in the present embodiment, when sequentially detecting the highest value MH and the lowest value ML of the rotation number which occur chronologically sequentially, a limitation is set on a time from detection of one of the values to detection of the other of the values. Specifically, in a case where the other of the values is detected before a predetermined time has elapsed since the one of the values was detected, a determination (such as a determination by comparison with the first threshold value x and with the second threshold value y) is made based on the difference between these two values.

Accordingly, if the highest value MH and the lowest value ML are sequentially detected due to a cause different from an impact, it is possible to exclude such detection result and thus suppress misdetection of an impact.

Further, in the present embodiment, in a case where the chronologically sequential highest value MH and the lowest value ML are detected, determination on an impact is performed based on the difference between these values only when both of these values are within the impact rotation number range. It is, therefore, possible to provide an increased accuracy in detecting an impact.

Moreover, in the present embodiment, even when the difference (the first difference) between the highest value MHn and the lowest value MLn is equal to or more than the first threshold value x, a confirmation determination that application of an impact is being performed is not made. A confirmation determination is made after subsequently comparing the difference (the second difference) between the next detected highest value MHn+1 and the lowest value MLn immediately before with the second threshold value y and determining that the second difference is equal to or more than the second threshold value y. By detecting an impact based on a plurality of times of determinations using different threshold values as described above, misdetection of an impact can be suppressed.

In the present embodiment, the upper limit threshold value Bu, the lower limit threshold value Bd, the first threshold x, and the second threshold y are set in a variable manner considering the battery voltage and the rotation direction. Accordingly, it is possible to set more appropriate respective threshold values in accordance with the battery voltage and the rotation direction, and thus provide an increased accuracy in detecting an impact.

### MODIFIED EXAMPLES

Although the embodiment of the present invention has been described above, it is to be understood that the present invention is not limited to the above described embodiment and various changes and modifications can be made without departing from the spirit and scope of the present invention.

For example, in connection with the difference between the chronologically sequentially occurring highest value MH and the lowest value ML, in the case where the first difference is equal to or more than the first threshold value x and also the subsequent second difference is equal to or more than the second threshold value y, an impact determination is made in the above embodiment. However, it may be possible instead to first make a comparison with the second threshold value y and then make a comparison with the first threshold value x.

Also, since the second threshold value y is smaller than the first threshold value x, the first threshold value x has a relatively higher reliability as a threshold value for impact detection than the second threshold value y. Accordingly, it may be possible, for example, to make a comparison with the first threshold value x once, and then make a plurality of times of comparison with the second threshold value y when the first difference is equal to or more than the first threshold value x, and then make an impact determination when comparison results of the plurality of times indicate that the second difference is equal to or more than the second threshold value y. In other words, in a case of making a plurality of times of determinations using a plurality of threshold values, it may be possible to make a larger times of determinations using a relatively less reliable threshold value (i.e., a smaller threshold value) among the plurality of threshold values.

Alternatively, instead of making a plurality of times of determinations, it may be possible to make a determination only once (that is, a determination only regarding the first difference) and make an impact determination when the first difference is equal to or more than the first threshold value x.

In the case of making a plurality of time of determinations, it may be possible to make the plurality of time of determinations using only the first threshold value x instead of the first threshold value x and the second threshold value y. For example, when the first difference is equal to or more than the first threshold value x, it may be possible to also make a second comparison between the second difference detected subsequently and the first threshold value x, and then make an impact determination when the second difference is also equal to or more than the first threshold value x.

In this case, if the second difference is smaller than the first threshold value x in the second comparison, it may be possible to immediately make a determination that an impact is not applied. Alternatively, it may be possible to determine whether or not a next difference (a difference between the highest value MHn+1 and the lowest value MLn+1; hereinafter referred to as the “third difference”) is equal to or more than the first threshold value x, and then make an impact determination when the third difference is equal to or more than the first threshold value x. Further alternatively, it may be possible to compare the third difference with the second threshold value y, and make a comparison between a further difference (a difference between the highest value MHn+2 and the lowest value MLn+1) and the first threshold value x if the third difference is equal to or more than the second threshold value y, and then make an impact determination when the further difference is equal to or more than the first threshold value x.

Furthermore, it may possible to make a comparison between each of three or more differences and the first threshold value x, and then make an impact determination when all the three or more differences are equal to or more than the first threshold value x. In this case, if any of the three or more differences is smaller than the first threshold value x, it may be possible to immediately make a determination that an impact is not applied. Alternatively, it may be possible to make a further comparison between the difference, which is smaller than the first threshold value x, and the second threshold value y. Then, if the difference is larger than the second threshold value y as a result of the further comparison, it may be possible to immediately make an impact determination, or may be possible to calculate a new difference and make an impact detection based on whether or not the new difference is equal to or more than the first threshold value x.

That is, it may be appropriately determined how many differences between the chronologically sequentially occurring highest value MH and lowest value ML, should be used to make a determination on an impact; whether or not to make a comparison with the second threshold value y if any difference is smaller than the first threshold value x; and what to do next (i.e., whether to make an impact determination or to make a further determination based on any other difference) if the difference is larger than the second threshold value y.

Although the two threshold values are set in the above embodiment, another threshold value may be set to make a determination on an impact. For example, if a difference is smaller than the first threshold value x and also smaller than the second threshold value y, it may be possible to make a comparison between the difference and a third threshold value z, which is smaller than the second threshold value y, and continue determination on an impact when the difference is equal to or larger than the third threshold value z. That is, it may be possible to appropriately determine a number of threshold values to be used for determination on an impact and specifically how to use a plurality of threshold values for determination on an impact.

The impact driver 1 may be used not only for tightening a screw but also removing (loosening) a screw. In a case of loosening a screw, it may be possible to also use an impact force to loosen the screw which is tightened up. In the case of loosening the screw, the motor 4 should be rotated in the reverse rotation direction on the contrary to the case of tightening. Also during the reverse rotation, the impact control process shown in FIG. 6 is executed in the above described embodiment.

In the case of loosening the screw using the impact force, once the screw is loosened and the motor 4 is in the no-load state, the motor 4 may be rotated at a high speed and the screw may fall off at once, resulting in a reduced working performance. Accordingly, in the case of loosening the screw by the reverse rotation, it is necessary to first detect an impact, subsequently detect termination of the impact, and then restrict the rotation number of the motor 4 when termination of the impact is detected.

FIG. 9 shows an example of changes in the rotation number of the motor 4 in the case of loosening a screw which is tightened up. As shown in FIG. 9, when a reverse rotation of the motor 4 is started to loosen the screw, application of an impact is started soon after start of the reverse rotation. The controller 31 detects the application of an impact during the reverse rotation in a same manner as in the impact control process shown in FIG. 6 (more specifically, the impact detection process in FIGS. 7A-7B). When the application of an impact is detected, detection of termination of the impact is performed subsequently.

Specifically, detection of termination of the impact is performed based on whether or not the rotation number of the motor 4 is equal to or more than a predetermined impact termination detection threshold value F (hereinafter referred to as the “threshold value F”). The threshold value F may be appropriately set within a range which is higher than the impact rotation number range (see FIG. 3) used in the impact detection process and lower than the rotation number in the no-load state.

When the rotation number of the motor 4 is increased due to termination of an impact and becomes equal to or more than the threshold value F (approximately at 940 ms in FIG. 9), it is determined that application of an impact has been terminated and restriction on the rotation number of the motor 4 is performed.

As described above, in the case of applying an impact when loosening a screw or the like, it is possible to suppress the screw or the like from falling off at once due to a high-speed rotation by restricting the rotation number of the motor 4 after the termination of the impact, and thus possible to avoid reduction in working performance.

Although it is described in the above embodiment that the controller 31 is constituted by a microcomputer, the controller 31 may be constituted by a programmable logic device, such as an ASIC (Application Specific Integrated Circuits), an FPGA (Field Programmable Gate Array), and the like.

Also, the aforementioned various control processes executed by the controller 31 are realized by the CPU, which constitutes the controller 31, executing respective programs. The programs may be written to the memory 41 in the controller 31, or may be stored in a recording medium from which the controller 31 can read data. As the recording medium, a portable semiconductor memory (such as a USB memory, a Memory Card (registered trademark)) may be employed.

Further, although it is described in the above embodiment that the motor 4 is constituted by a three-phase brushless motor, any motor may be employed as long as the motor is capable of rotating the output shaft to which a tool element is attached.

The present invention may be applied not only to a battery-type tool but also to a tool receiving power supply through a cord, or may be applied to a rotary impact tool configured to rotate a tool element by an AC motor.

Further more, each of the switching devices Q1 to Q6 constituting the motor drive circuit 33 may be a switching device other than a MOSFET (such as a bipolar transistor).

Moreover, although it is described in the above embodiment that the battery 29 is a lithium-ion secondary battery, by way of example, the battery 29 may be another secondary battery, such as a nickel hydride secondary battery or a nickel cadmium secondary battery.

What is claimed is:

1. A rotary impact tool comprising:
a motor;
a hammer configured to be rotated by a rotational force of the motor;
an anvil that is mounted with an output shaft to which a tool element is attached, and is configured to be rotated receiving a rotational force of the hammer and to be intermittently applied with an impact force in a rotation direction of the hammer by the rotational force of the hammer when an external torque of a predetermined value or more is exerted due to a rotation of the anvil;
a rotation speed detection device configured to detect a rotation speed of the motor;
an extreme value pair detection device configured to detect an extreme value pair, which is a pair of a maximum value and a minimum value of the rotation speed occurring chronologically sequentially, based on the rotation speed detected by the rotation speed detection device; and
an impact detection device configured to detect that the impact force is being applied when an extreme value difference, which is a difference between the maximum value and the minimum value constituting the extreme value pair detected by the extreme value pair detection device, is equal to or more than a first threshold value.

2. The rotary impact tool according to claim 1, wherein the extreme value pair detection device is configured to detect the maximum value and the minimum value as the extreme value pair when the maximum value and the minimum value occur chronologically sequentially within a predetermined time period.

3. The rotary impact tool according to claim 1, wherein the impact detection device is configured to detect that, with respect to a plurality of the extreme value pairs which are chronologically different from one another, the impact force is being applied one of when the extreme value difference of each of the plurality of the extreme value pairs is equal to or more than the first threshold value, and when the extreme value difference of at least one of the extreme value pairs is equal to or more than the first threshold value and the extreme value difference of each of the other extreme value pairs is equal to or more than a second threshold value which is smaller than the first threshold value.

4. The rotary impact tool according to claim 3, wherein the impact detection device is configured to, with respect to two of the extreme value pairs which are chronologically different from each other:
first determine whether or not the extreme value difference of the extreme value pair which is detected earlier is equal to or more than the first threshold value, and
subsequently determine, when the extreme value difference is equal to or more than the first threshold value, whether or not the extreme value difference of the extreme value pair which is detected later is equal to or more than the second threshold value, and
detect, when the extreme value difference of the extreme value pair which is detected later is equal to or more than the second threshold value, that the impact force is being applied.

5. The rotary impact tool according to claim 1, wherein the impact detection device is configured to, after starting detection based on the extreme value difference by the impact detection device it self:
detect, when the extreme value difference of a first one of the extreme value pairs is equal to or more than the first threshold value, that the impact force is being applied,
determine, when the extreme value difference of the first one of the extreme value pairs is not equal to or more than the first threshold value, whether or not the extreme value difference of the first one of the extreme value pairs is equal to or more than a second threshold value, which is smaller than the first threshold value,
subsequently determine, when the extreme value difference of the first one of the extreme value pairs is equal to or more than the second threshold value, whether or not the extreme value difference of at least one of the extreme value pairs chronologically later than the first one of the extreme value pairs is equal to or more than the first threshold value, and
detect, when the extreme value difference of the at least one of the extreme value pairs is equal to or more than the first threshold value, that the impact force is being applied.

6. The rotary impact tool according to claim 1, further comprising:
a rotation number range determination device configured to determine whether or not both of the maximum value and the minimum value constituting the extreme value pair are within a predetermined rotation number range,
wherein the impact detection device is configured to determine, when it is determined by the rotation number range determination device that both of the maximum value and the minimum value constituting the extreme value pair are within the predetermined rotation number range, whether or not the impact force is being applied based on the extreme value pair.

7. The rotary impact tool according to claim 6, further comprising:
at least one of a voltage detection device configured to detect a voltage of a power source for supplying power to the motor, and a rotation direction detecting device configured to detect whether a rotation direction of the motor is a predetermined forward rotation direction or a reverse rotation direction; and
a rotation number range setting device configured to set the rotation number range based on a detection result by at least one of the voltage detection device and the rotation direction detecting device.

8. The rotary impact tool according to claim 7,
wherein one of a rotation speed in the forward rotation direction and a rotation speed in the reverse rotation direction is relatively higher than the other rotation speed, and
wherein the rotation number range setting device sets the rotation number range such that the rotation number range is in a region of higher rotation numbers as the voltage detected by the voltage detection device is larger, and such that, with respect to the rotation direction detected by the rotation direction detecting device, the rotation number range is in a region of higher rotation numbers in a case of the rotation direction with a higher rotation speed.

9. The rotary impact tool according to claim 1, further comprising:
at least one of a voltage detection device configured to detect a voltage of a power source for supplying power to the motor, and a rotation direction detecting device configured to detect whether a rotation direction of the motor is a predetermined forward rotation direction or a reverse rotation direction; and
a threshold value setting device configured to set the threshold value based on a detection result by at least one of the voltage detection device and the rotation direction detecting device.

10. The rotary impact tool according to claim 9,
wherein one of a rotation speed in the forward rotation direction and a rotation speed in the reverse rotation direction is relatively higher than the other rotation speed, and
wherein the threshold value setting device sets the threshold value such that the threshold value becomes smaller as the voltage detected by the voltage detection device is larger, and such that, with respect to the rotation direction detected by the rotation direction detecting device, the threshold value is smaller in a case of the rotation direction with a higher rotation speed.

11. The rotary impact tool according to claim 1, further comprising:
a first rotation speed restriction device configured to restrict the rotation speed of the motor when it is detected by the impact detection device that the impact force is being applied.

12. The rotary impact tool according to claim 1, further comprising:
a rotation direction detecting device configured to detect whether a rotation direction of the motor is a predetermined forward rotation direction or a reverse rotation direction;
an impact termination determination device configured to determine, when it is detected by the rotation direction detecting device that the rotation direction is the reverse rotation direction and it is also detected by the impact detection device that the impact force is being applied, whether or not application of the impact force has been terminated; and
a second rotation speed restriction device configured to restrict the rotation speed of the motor when it is determined by the impact termination determination device that application of the impact force has been terminated.

13. The rotary impact tool according to claim 1, further comprising:
a Hall IC configured to output a signal in accordance with a rotational position of the motor,
wherein the rotation speed detection device detects the rotation speed based on the signal outputted from the Hall IC.
